(19) United States
(12) Patent Application Publication
(10) Pub. No.: US 2014/0320685 A1
(43) Pub. Date: Oct. 30, 2014

(54) IMAGING APPARATUS AND IMAGING SYSTEM

(71) Applicant: CANON KABUSHIKI KAISHA, TOKYO (JP)

(72) Inventors: Katsuro Takenaka, Honjo-shi (JP); Toshio Kameshima, Kumagaya-shi (JP); Tomoyuki Yagi, Honjo-shi (JP); Sho Sato, Saitama-shi (JP); Atsushi Iwashita, Saitama-shi (JP); Eriko Sato, Tokyo (JP); Hideyuki Okada, Honjo-shi (JP); Takuya Ryu, Kokubunji-shi (JP)

(21) Appl. No.: 14/251,965

(22) Filed: Apr. 14, 2014

(30) Foreign Application Priority Data
Apr. 24, 2013 (JP) 2013-091785

(51) Int. Cl. H04N 5/232

(52) U.S. Cl. CPC H04N 5/23232
USPC 348/218.1

(57) ABSTRACT

An imaging apparatus, comprising a sensor array in which a plurality of sensors are arrayed, a first readout unit configured to read out, from each of the plurality of sensors, a first signal corresponding to an amount of one of an electron and a hole of each of electron-hole pairs generated in the sensor array in response to irradiation with radiation or light, and a second readout unit configured to read out, from each of the plurality of sensors, a second signal corresponding to an amount of the other of the electron and the hole of the electron-hole pairs.

### BACKGROUND OF THE INVENTION

1. Field of the Invention

The present invention relates to an imaging apparatus and an imaging system.

2. Description of the Related Art

An imaging apparatus includes a sensor array in which a plurality of sensors are arrayed, a signal readout unit configured to read out signals from the sensor array, and a generation unit configured to generate image data based on the readout signals. As described in Japanese Patent Laid-Open Nos. 8-116044 and 2010-268171, a signal readout unit reads out a signal corresponding to the amount of charge generated in each sensor upon irradiation with radiation or light.

The arrangement of an imaging apparatus which individually reads out electrons and holes generated in each sensor, and uses both the electrons and the holes, or either the electrons or holes to generate image data has not been disclosed. Therefore, only either the electrons or the holes have been conventionally read out and used to generate image data. It is possible to improve the performance of an imaging apparatus by individually reading out the electrons and holes as two signals.

### SUMMARY OF THE INVENTION

The present invention has been made in recognition of the above problem by the inventor, and provides a technique advantageous in improving the performance of an imaging apparatus.

One of the aspects of the present invention provides an imaging apparatus, comprising a sensor array in which a plurality of sensors are arrayed, a first readout unit configured to read out, from each of the plurality of sensors, a first signal corresponding to an amount of one of an electron and a hole of each of electron-hole pairs generated in the sensor array in response to irradiation with radiation or light, and a second readout unit configured to read out, from each of the plurality of sensors, a second signal corresponding to an amount of the other of the electron and the hole of the electron-hole pairs.

Further features of the present invention will become apparent from the following description of exemplary embodiments with reference to the attached drawings.

### BRIEF DESCRIPTION OF THE DRAWINGS

FIG. 1 is a block diagram for explaining an example of the arrangement of a radiation inspection apparatus;

FIG. 2 is a circuit diagram for explaining an example of the circuit arrangement of a radiation imaging apparatus according to the first embodiment;

FIG. 3 is a timing chart for explaining the operation of the radiation imaging apparatus according to the first embodiment;

FIGS. 4A and 4B are views for explaining an example of the detailed arrangement of the radiation imaging apparatus according to the first embodiment;

FIG. 5 is a circuit diagram for explaining the influence of external noise;

FIG. 6 is a circuit diagram for explaining another example of the arrangement of the radiation imaging apparatus according to the first embodiment;

FIG. 7 is a circuit diagram for explaining an example of the circuit arrangement of a radiation imaging apparatus according to the second embodiment;

FIG. 8 is a graph for explaining an example of a method of driving a radiation imaging apparatus according to the third embodiment;

FIG. 9 is a circuit diagram for explaining an example of the circuit arrangement of a radiation imaging apparatus according to the fourth embodiment;

FIG. 10 is a view for explaining an example of a method of driving the radiation imaging apparatus according to the fourth embodiment;

FIG. 11 is a circuit diagram for explaining an example of the circuit arrangement of a radiation imaging apparatus according to the fifth embodiment;

FIG. 12 is a view for explaining an example of a method of driving the radiation imaging apparatus according to the fifth embodiment; and

FIG. 13 is a timing chart for explaining an example of a method of driving a radiation imaging apparatus according to the sixth embodiment.

### DESCRIPTION OF THE EMBODIMENTS

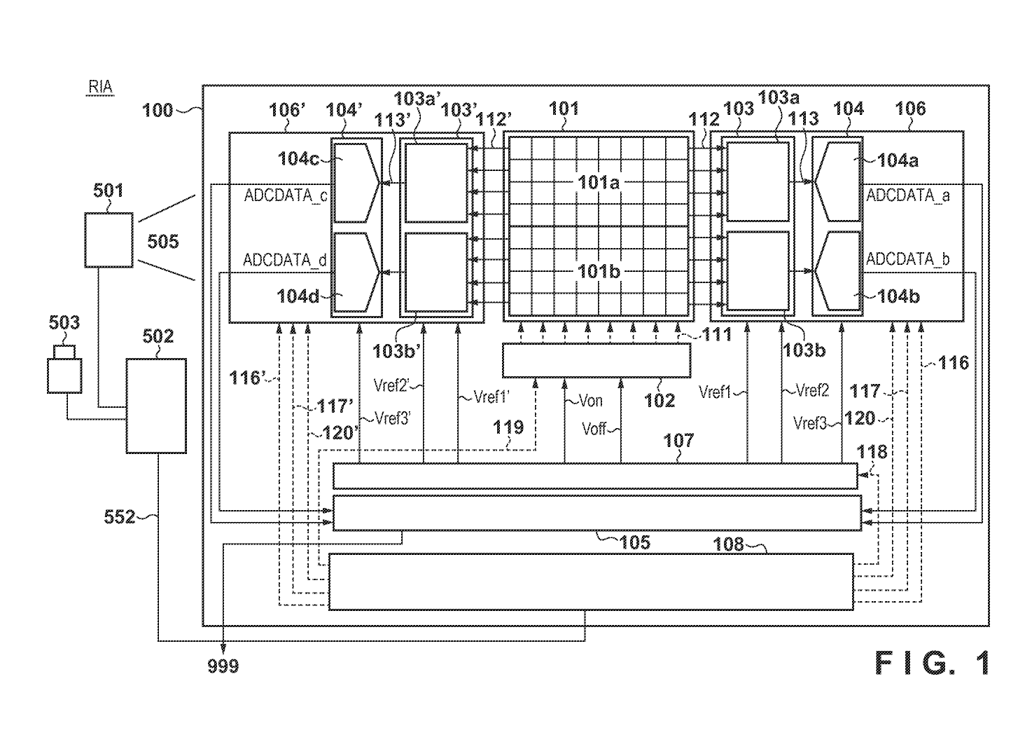

FIG. 1 is a block diagram showing the arrangement of a radiation inspection apparatus RIA as an example of an imaging system. In addition to a radiation imaging apparatus 100, the radiation inspection apparatus RIA can include, for example, a radiation source 501, an emission switch 503, and a radiation control apparatus 502. Based on, for example, a communication signal 552, the radiation control apparatus 502 can confirm with the radiation imaging apparatus 100 whether radiation irradiation can be performed. In response to press of the emission switch 503, a control signal from the radiation control apparatus 502 is input to the radiation source 501. In response to the control signal, the radiation source 501 emits radiation 505. The radiation imaging apparatus 100 then obtains image data corresponding to the radiation 505 having passed through a subject to be examined (not shown). Although X-rays can be used as a representative example of radiation 505, radiation can include α-rays, β-rays, and γ-rays.

The radiation imaging apparatus 100 (to be referred to as an “imaging apparatus 100” hereinafter) can include a detection unit 101, a driving unit 102, readout units 106 and 106′, an image data generation unit 105, a power supply unit 107, and a control unit 108.

The detection unit 101 can be formed by arraying a plurality of pixels. The detection unit 101 can include a sensor array (not shown) in which sensors (to be described later) are arranged to correspond to the respective pixels, and a scintillator layer (not shown) formed on the sensor array. The scintillator layer converts the radiation 505 into light, which is then detected by the sensors. Note that an arrangement which uses a so-called indirect conversion sensor that adopts a method of causing a scintillator layer to convert radiation into light, and photoelectrically converting the light into an electronic signal using a photoelectric conversion element made of amorphous silicon or the like will be exemplified in this example. The present invention, however, is not limited to this arrangement. For example, a radiation imaging apparatus which uses a so-called direct conversion sensor that adopts a method of directly converting radiation into an electronic signal using, as a sensor, a conversion element made of amorphous selenium or the like may be used. Note that the sensor is an element for directly or indirectly converting radiation into an electronic signal, and the sensor array is formed by arraying a plurality of pixels each including a sensor in a matrix.

The detection unit 101 also includes switch elements (to be described later) for reading out signals from the respective sensors, which are arranged to correspond to the respective sensors. The detection unit 101 is divided into, for example, a first group 101a and a second group 101b. The readout units 106 and 106′ read out signals from the first group 101a and the second group 101b.

The driving unit 102 drives the detection unit 101 (the respective pixels thereof) for each row, thereby causing the readout unit 106 to read out a signal from each sensor.

The readout unit 106 can include a processing unit 103 with a first processing unit 103a and a second processing unit 103b, and an A/D converter 104 with a first A/D converter 104a and a second A/D converter 104b. Similarly to the readout unit 106, the readout unit 106′ can include a processing unit 103′ with a first processing unit 103a′ and a second processing unit 103b′, and an A/D converter 104′ with a first A/D converter 104c and a second A/D converter 104d.

For example, the first processing unit 103a reads out signals 112 from the first group 101a of the detection unit 101. The first A/D converter 104a performs A/D conversion (analog/digital conversion) for a signal 113 from the first processing unit 103a, thereby obtaining a signal ADCDATA_a. Similarly, signals ADCDATA_b, ADCDATA_c, and ADCDATA_d are obtained from the remaining processing units (103b, 103a′, and 103b′) and A/D converters (104b, 104c, and 104d), respectively.

The image data generation unit 105 generates image data based on the signals ADCDATA_a, ADCDATA_b, ADCDATA_c, and ADCDATA_d, and outputs the generated image data to the outside as a signal 999. In generating image data, the image data generation unit 105 can perform correction processing such as offset correction, gain correction, fixed pattern noise (FPN) correction, and white balance correction.

The power supply unit 107 supplies a corresponding power to each of the above-described units (for example, the driving unit 102 and readout units 106 and 106′). For example, the power supply unit 107 supplies a first reference voltage Vref1 and a second reference voltage Vref2 to the processing unit 103, and supplies a third reference voltage Vref3 to the A/D converter 104. Similarly, the power supply unit 107 supplies a first reference voltage Vref1′ and a second reference voltage Vref2′ to the processing unit 103′, and supplies a third reference voltage Vref3′ to the A/D converter 104′. Furthermore, the power supply unit 107 supplies, to the driving unit 102, an ON bias voltage Von for setting each switch element of the detection unit 101 in a conductive state, and an OFF bias voltage Voff for setting each switch element of the detection unit 101 in a non-conductive state.

The control unit 108 controls the above-described units (for example, the driving unit 102, power supply unit 107, and readout units 106 and 106′). For example, the control unit 108 outputs a control signal 119 to the driving unit 102. In response to the control signal 119, the driving unit 102 drives the detection unit 101 by control signals 111. Furthermore, for example, the control unit 108 outputs a control signal 118 to the power supply unit 107. In response to the control signal 118, the power supply unit 107 supplies a power or bias voltage to each unit. In addition, for example, the control unit 108 outputs respective control signals 116, 117, and 120 to the readout unit 106, and outputs respective control signals 116′, 117′, and 120′, thereby controlling the readout units 106 and 106′.

### First Embodiment

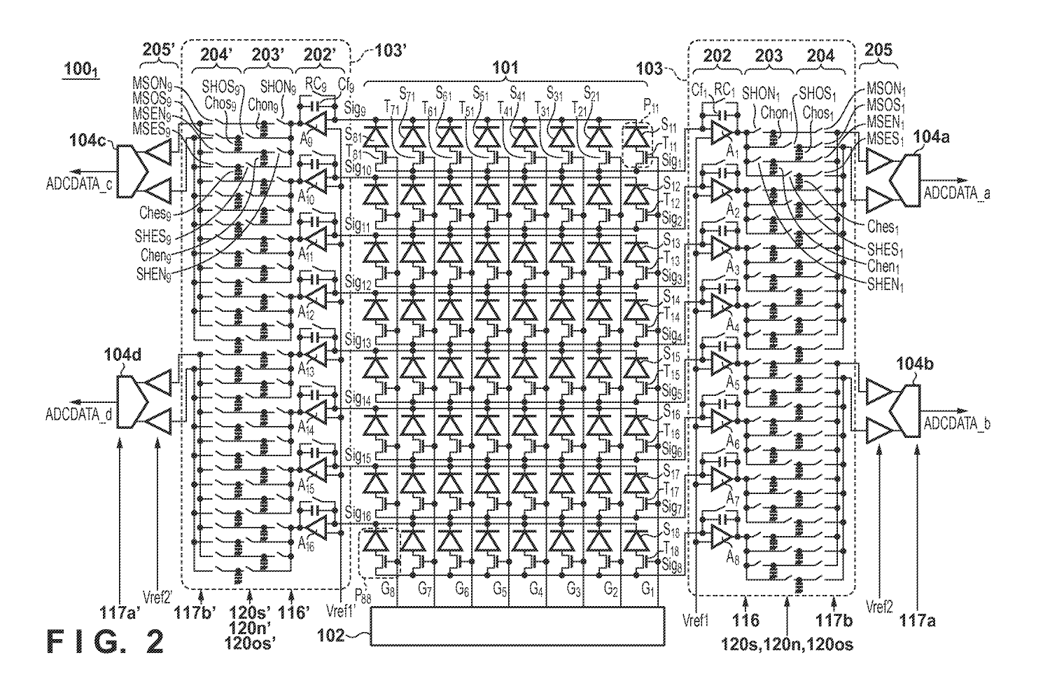

An imaging apparatus 100₁ according to the first embodiment will be described with reference to FIGS. 2 to 6. FIG. 2 shows an example of the arrangement of a portion of the imaging apparatus 100₁, which includes a detection unit 101, a driving unit 102, and readout units 106 and 106′. In the detection unit 101, a plurality of pixels P are arrayed to form a plurality of rows and a plurality of columns. For the sake of simplicity, FIG. 2 shows an arrangement in which 8 (row)×8 (column) pixels P, that is, P₁₁ to P₈₈ are arrayed. The respective pixels P include sensors S, that is, S₁₁ to S₈₈ and switch elements T, that is, T₁₁ to T₈₈. In this example, the sensor S is a photoelectric conversion element, and a signal corresponding to the amount of charge generated by light from the above-described scintillator layer and accumulated can be read out from each sensor S.

For example, the detection unit 101 can be formed on an insulating substrate such as a glass substrate by using amorphous silicon. As the sensor S, for example, a PIN sensor or MIS sensor is usable. As the switch element T, for example, a thin film transistor (TFT) is usable. Note that in this embodiment, a PIN photodiode is used as the sensor S.

Signal lines G, that is, G₁ to G₈ for controlling the sensors S are arranged in the detection unit 101 in correspondence with the respective rows. The control signals from the driving unit 102 are input to the control terminals of the corresponding switch elements T via the signal lines G₁ to G₈, respectively. First signal lines Sig₁ to Sig₈ and second signal lines Sig₉ to Sig₁₆ for reading out signals from the respective sensors S are arranged in the detection unit 101 in correspondence with the respective columns. When signals from the driving unit 102 are activated, the switch elements T are set in a conductive state, and signals of the respective sensors S are input to the processing unit 103 or 103′ via the signal lines Sig₁ to Sig₈ or Sig₉ to Sig₁₆.

A signal (to be referred to as a “first signal” hereinafter) of a first polarity corresponding to the amount of one (in this example, hole) of the electron and hole of each of electron-hole pairs generated in each sensor S is input to the processing unit 103 via a corresponding one of the signal lines Sig₁ to Sig₈. A signal (a second signal) of a second polarity corresponding to the amount of the other (in this example, electron) of the electron and hole of each of the electron-hole pairs is input to the processing unit 103′ via a corresponding one of the signal lines Sig₉ to Sig₁₆. Note that in this embodiment, the anode of the PIN photodiode serving as the sensor S is electrically connected to a corresponding one of the signal lines Sig₁ to Sig₈ via the corresponding switch element T. Furthermore, the cathode of the PIN photodiode is electrically connected to a corresponding one of the signal lines Sig₉ to Sig₁₆. Note that the present invention is not limited to this, and the anode of the PIN photodiode may be electrically connected to a corresponding one of the signal lines Sig₉ to Sig₁₆, and the cathode of the PIN photodiode may be electrically connected to a corresponding one of the signal lines Sig₁ to Sig₈ via the corresponding switch element T. In this case, the second signal is input to the processing unit 103 via a corresponding one of the signal lines Sig₁ to Sig₈, and the first signal is input to the processing unit 103′ via a corresponding one of the signal lines Sig₉ to Sig₁₆.

The processing unit 103 will be described below, and the same goes for the processing unit 103′, too. The processing unit 103 can include amplification circuits 202, sample and hold circuits 203, and multiplexers 204. The first signal can be amplified by a corresponding one of the amplification circuits 202 (amplification units), and sampled by a corresponding one of the sample and hold circuits 203. The sampled signals can be sequentially output to an A/D converter 104 via a variable amplifier 205 from the respective multiplexers 204 for each column.

The amplification circuit 202 corresponding to, for example, a first column can be constructed using an operational amplifier A₁, an integral capacitor Cf₁, and a reset switch RC₁. The first signal from the sensor S is input to the inverting input terminal of the operational amplifier A₁, and a reference voltage Vref1 is input to the non-inverting input terminal of the operational amplifier A₁. The first signal is amplified by the operational amplifier A₁, and output from an output terminal. The inverting input terminal and non-inverting input terminal of the operational amplifier A₁ are imaginarily short-circuited, and the voltage of the signal line Sig₁ is set to the reference voltage Vref1. Note that each of operational amplifiers A₂ to A₈ respectively corresponding to the second to eighth columns has the same arrangement as that of the operational amplifier A₁ of the first column.

The sample and hold circuit 203 corresponding to, for example, the first column can be constructed using sampling switches SHON₁, SHOS₁, SHEN₁, and SHES₁, and sampling capacitors Chon₁, Chos₁, Chen₁, and Ches₁. For example, sampling of noise components in the readout operation of the sensors S on the odd-numbered rows (rows corresponding to the signal lines G₁, G₂, G₅, and G₇) can be performed using the sampling switch SHON₁ and the sampling capacitor Chon₁. For example, sampling of signal components (in this example, the first signals) in the readout operation of the sensors S on the odd-numbered rows can be performed using the sampling switch SHOS₁ and the sampling capacitor Chos₁. For example, sampling of noise components in the readout operation of the sensors S on the even-numbered rows (rows corresponding to the signal lines G₂, G₄, G₆, and G₈) can be performed using the sampling switch SHEN₁ and the sampling capacitor Chen₁. For example, sampling of signal components in the readout operation of the sensors S on the even-numbered rows can be performed using the sampling switch SHES₁ and the sampling capacitor Ches₁. In the above-described arrangement, the sample and hold circuit 203 can perform correlated double sampling (CDS). Each of the sample and hold circuits 203 respectively corresponding to the second to eighth columns has the same arrangement as that of the sample and hold circuit 203 of the first column.

The multiplexer 204 corresponding to, for example, the first column includes switches MSON₁, MSEN₁, MSOS₁, and MSES₁. The multiplexer 204 sequentially sets the switches in a conductive state, and outputs the first signals parallelly read out from the sample and hold circuit 203. Each of the multiplexers 204 respectively corresponding to the second to eighth columns has the same arrangement as that of the multiplexer 204 of the first column.

Note that a first processing unit 103a (FIG. 1) corresponds to the amplification circuits 202, sample and hold circuits 203, and multiplexers 204, which are arranged to correspond to the first to fourth columns, and a second processing unit 103b corresponds to the amplification circuits 202, sample and hold circuits 203, and multiplexers 204, which are arranged to correspond to the fifth to eighth columns.

The processing unit 103′ can have the same arrangement as that of the processing unit 103. For example, an amplification circuit 202′ corresponding to the first column can be constructed using an operational amplifier A₉, an integral capacitor Cf₉, and a reset switch RC₉.

The reference voltage Vref1 supplied to the non-inverting input terminal of the operational amplifier A₁ and a reference voltage Vref1′ supplied to the non-inverting input terminal of the operational amplifier A₉ can satisfy a relation Vref1<Vref1′. When, for example, the power supply voltage is set to 5V, Vref1 is preferably set to, for example, 0.5V and Vref1′ is preferably set to, for example, 4.5V. This sets the respective sensors S₁₁ to S₈₈ in a reverse bias state, thereby allowing the respective sensors S₁₁ to S₈₈ to perform photoelectric conversion.

In the above-described arrangement, signals from the multiplexers 204 and multiplexers 204′ are amplified by the variable amplifier 205 and a variable amplifier 205′, converted into digital data by the A/D converter 104 and an A/D converter 104′, and then output to an image data generation unit 105, respectively. The image data generation unit 105 generates image data based on the signals ADCDATA_a, ADCDATA_b, ADCDATA_c, and ADCDATA_d from the A/D converters 104 and 104′.

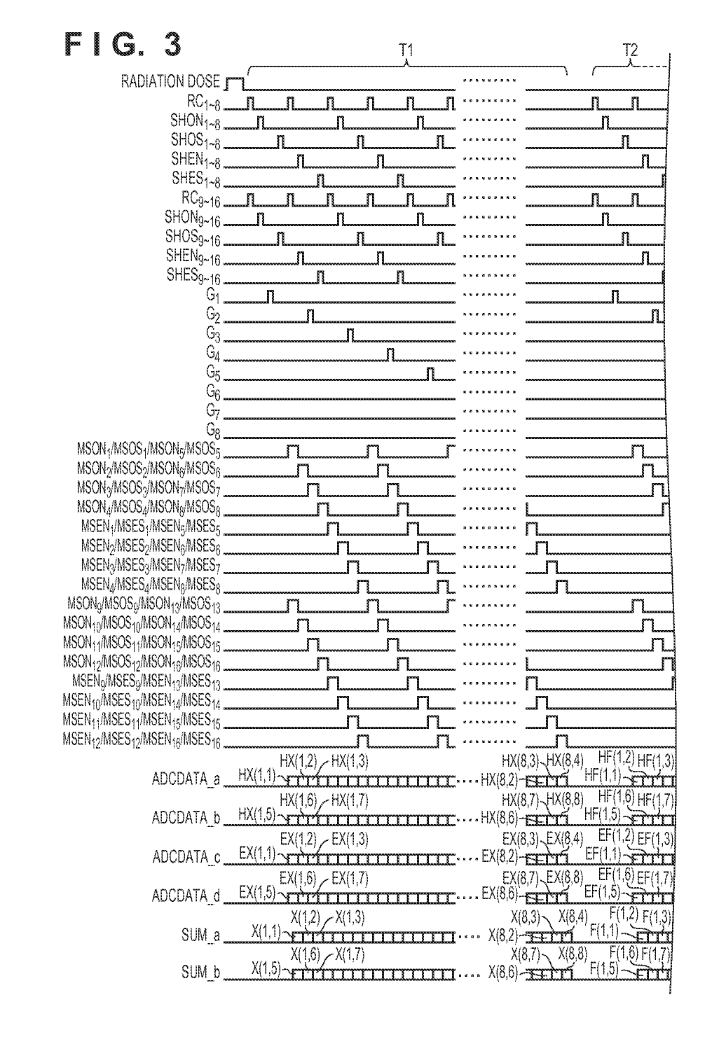

FIG. 3 is a timing chart showing an example of the operation of the imaging apparatus 100₁. FIG. 3 shows, from above, a radiation dose, control signals for the amplification circuits 202 and 202′, control signals for the sample and hold circuits 203 and 203′, control signals from the driving unit 102, and control signals for the multiplexers 204 and 204′. The control signals for the amplification circuits 202 and 202′ indicate signals for switching the states of the reset switches RC₁ to RC₁₆, respectively. Each reset switch RC is set in a conductive state when a corresponding control signal is at high level, and in a non-conductive state at low level. The control signals for the sample and hold circuits 203 and 203′ indicate signals for switching the states of the sampling switches SHON₁, SHOS₁, SHEN₁, SHES₁, and the like, respectively. Each sampling switch is set in a conductive state when a corresponding control signal is at high level, and in a non-conductive state at low level. The control signals from the driving unit 102 indicate signals which propagate through the signal lines G₁ to G₈, and switch the states of the respective switch elements T, respectively. Each switch element T is set in a conductive state when a corresponding control signal is at high level, and in a non-conductive state at low level. The control signals for the multiplexers 204 and 204′ indicate signals for switching the states of the switches MSON₁, MSEN₁, MSOS₁, MSES₁, and the like of the multiplexers 204 and 204′, respectively. Each switch is set in a conductive state when a corresponding control signal is at high level, and in a non-conductive state at low level.

In the lower portion of FIG. 3, data obtained by the A/D converters 104 and 104′ and data obtained by the image data generation unit 105 are shown. The data obtained by the A/D converters 104 and 104′ indicate the above-described signals ADCDATA_a, ADCDATA_b, ADCDATA_c, and ADCDATA_d. During a first period T1 after irradiation with radiation, HX(1, 1) or the like represents data obtained based on the first signal, and EX(1, 1) or the like represents data obtained based on the second signal. During a second period T2 after the first period T1, HF(1, 1) or the like represents data obtained based on the first signal, and EF(1, 1) or the like represents data obtained based on the second signal. The data obtained by the image data generation unit 105 indicate data obtained based on the above-described signals ADCDATA_a, ADCDATA_b, ADCDATA_c, and ADCDATA_d. X(1, 1) or the like represents data obtained during the first period T1, and F(1, 1) or the like represents data obtained during the second period T2.

Before irradiation with radiation, in response to a control signal from a control unit 108, a power supply unit 107 supplies a power to each unit, thereby setting the imaging apparatus 100₁ in a standby state. Upon irradiation with radiation, each sensor S generates and accumulates charges (electron-hole pairs).

A predetermined reset operation is performed before a first signal corresponding to the amount of one of the electron and hole of each of the electron-hole pairs and a second signal corresponding to the amount of the other of the electron and hole of each of the electron-hole pairs are read out from each sensor S. More specifically, the integral capacitors Cf₁ to Cf₁₆ of the respective processing units 103a, 103b, 103a′, and 103b′ are reset. This is done by sequentially setting the reset switches RC₁ to RC₈ and RC₉ to RC₁₆ in a conductive state, as shown in FIG. 3, and equalizing the voltages across the integral capacitors Cf₁ to Cf₁₆.

After resetting the integral capacitors Cf₁ to Cf₁₆, the sampling switches SHON₁ to SHON_{E} and SHON₉ to SHON₁₆ are set in a conductive state. The outputs of the amplification circuits 202 and 202′ immediately after the reset operation are held by the sampling capacitors Chon₁ to Chon₈ and Chon₉ to Chon₁₆ as noise levels. Note that a period during which the sampling switch SHON is in a conductive state can be determined based on the relationship between a sampling period and the capacitance value of the sampling capacitor Chon.

The respective switch elements T₁₁ to T₁₈ are set in a conductive state by activating the signal of the signal line G₁. The first signals of the respective sensors S₁₁ to S₁₈ are input to the processing unit 103 via the signal lines Sig₁ to Sig₈, respectively. The second signals are input to the processing unit 103′ via the signal lines Sig₉ to Sig₁₆, respectively.

The sampling switches SHOS₁ to SHOS₈ and SHOS₉ to SHOS₁₆ are set in a conductive state. As a result, the first signals and the second signals are held by the sampling capacitors Chos₁ to Chos₈ and Chos₉ to Chos₁₆ as signal levels, respectively.

After that, the switches MSON₁ to MSON₈ and MSOS₁ to MSOS₈ of the multiplexers 204 and the switches MSON₉ to MSON₁₆ and MSOS₉ to MSOS₁₆ of the multiplexers 204′ are sequentially set in a conductive state. Consequently, the signals of the sample and hold circuits 203 are sequentially output to the A/D converters 104 and 104′. These signals are converted into digital data by the A/D converters 104 and 104′, and output to the image data generation unit 105. The above-described operation is performed in the same manner up to the eighth row, thereby reading out pixel signals from the respective pixels P of the detection unit 101.

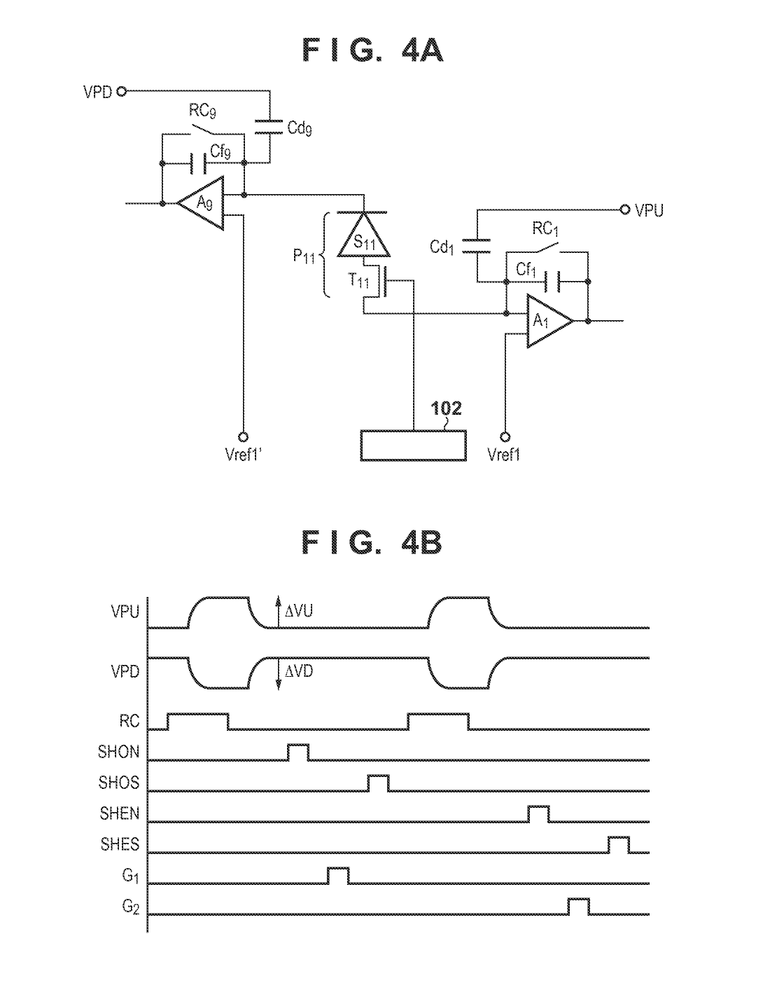

In this case, as described above, Vref1<Vref1′ is satisfied. Assuming that the power supply voltage is set to 5V, for example, Vref1 can be set to 0.5V and Vref1′ can be set to 4.5V. In the operational amplifier A₁, for example, the first signals from the respective sensors S₁₁ to S₈₁ change the voltage of the output terminal of the operational amplifier A₁ within the range of 0.5 V to 0 V. That is, the output range (width) of the operational amplifier A₁ is 0.5 V, which is an insufficient output range. In the operational amplifier A₉, the second signals from the sensors S₁₁ to S₈₁ change the voltage of the output terminal of the operational amplifier A₉ within the range of 4.5 V to 5.0 V. That is, the output range of the operational amplifier A₉ is 0.5 V, which is an insufficient output range. To solve this problem, as exemplified in FIGS. 4A and 4B, a unit (output range extension unit) for extending the output range of the operational amplifier A may be added.

FIG. 4A shows a portion of the circuit arrangement of the imaging apparatus 100₁, which includes the pixel P₁₁, and the amplification circuits 202 and 202′ corresponding to the pixel P₁₁ in the processing units 103 and 103′. Although not shown in FIG. 2, the operational amplifier A₁ is connected to a capacitor Cd1 which has one terminal connected to the inverting input terminal of the operational amplifier A₁ and the other terminal serving as a terminal VPU connected to a first pulse power supply. Similarly, the operational amplifier A₉ is connected to a capacitor Cd9 which has one terminal connected to the inverting input terminal of the operational amplifier A₉ and the other terminal serving as a terminal VPD connected to a second pulse power supply.

FIG. 4B is a timing chart showing part of the operation of the imaging apparatus 100₁. For the sake of simplicity, FIG. 4B shows the voltages of the terminals VPU and VPD, and some (RC, SHON, SHOS, SHEN, SHES, G1, and G2) of the control signals shown in FIG. 3. After the reset switch RC is set in a conductive state to reset the integral capacitor Cf, and then set in a non-conductive state, pulse signals are input from a pulse voltage source (not shown) to the terminals VPU and VPD, as shown in FIG. 4B. For example, a pulse signal having a potential difference AVU is input to the terminal VPU, and a pulse signal having a potential difference ΔVP is input to the terminal VPD. This can cause the output of the operational amplifier A₁ to have an offset voltage ΔVU×Cd1/Cf1, and the output of operational amplifier A₉ to have an offset voltage ΔVP×Cd9/Cf9. If, for example, ΔVU=1 V, Cd1=4 pF, Cf1=1 pF, the output of the operational amplifier A₁ after the reset switch RC1 is set in a conductive state is 0.5 but an offset of +4 V is added to the output of the operational amplifier A₁, resulting in 4.5 V. Therefore, the output of the operational amplifier A₁ changes within the range of 4.5 V to 0 V. That is, the output range of the operational amplifier A₁ can be extended to 4.5 V. Similarly, the output of the operational amplifier A₉ changes within the range of 0.5 V to 5.0 V. That is, the output range of the operational amplifier A₉ can be extended to 4.5 V. Note that the capacitors Cd1 and Cd9 may be arranged in the processing unit 103 or the detection unit 101.

Referring to FIG. 3, HX(1, 1) represents digital data obtained based on the first signal from the sensor S₁₁ during the first period T1, and EX(1, 1) represents digital data obtained based on the second signal from the sensor S₁₁. The image data generation unit 105 adds the digital data HX(1, 1) and EX(1, 1), thereby obtaining data X(1, 1). The image data generation unit 105 executes the same processing for the digital data obtained from each of the remaining sensors S, thereby obtaining data X(m, n) (m=1 to 8 and n=1 to 8). Note that although a detailed description will be omitted, the same operation may be performed during the second period T2 to obtain data F(m, n), thereby calculating the difference between data X(m, n) and F(m, n).

By arranging the processing units 103 and 103′ so that their gains become equal, the values of HX(1, 1) and EX(1, 1) become almost equal to each other. It is possible to equalize the gains of the processing units 103 and 103′ by, for example, equalizing the capacitance values of the respective integral capacitors Cf, and equalizing the gains of the variable amplifiers 205 and 205′. The number of signal components is doubled by, for example, adding the thus obtained two data, as compared with a case in which image data is generated based on only one of the first signal and second signal. On the other hand, since a noise level is determined based on the wiring capacitance of a signal line and the arrangement of each circuit, the noise levels of the processing units 103 and 103′ become equal to each other by forming them with the same circuit arrangement and layout arrangement. As a result, in the imaging apparatus 100₁, an S/N ratio is 2^{1/2} times that obtained when image data is generated based on only one of the first signal and second signal.

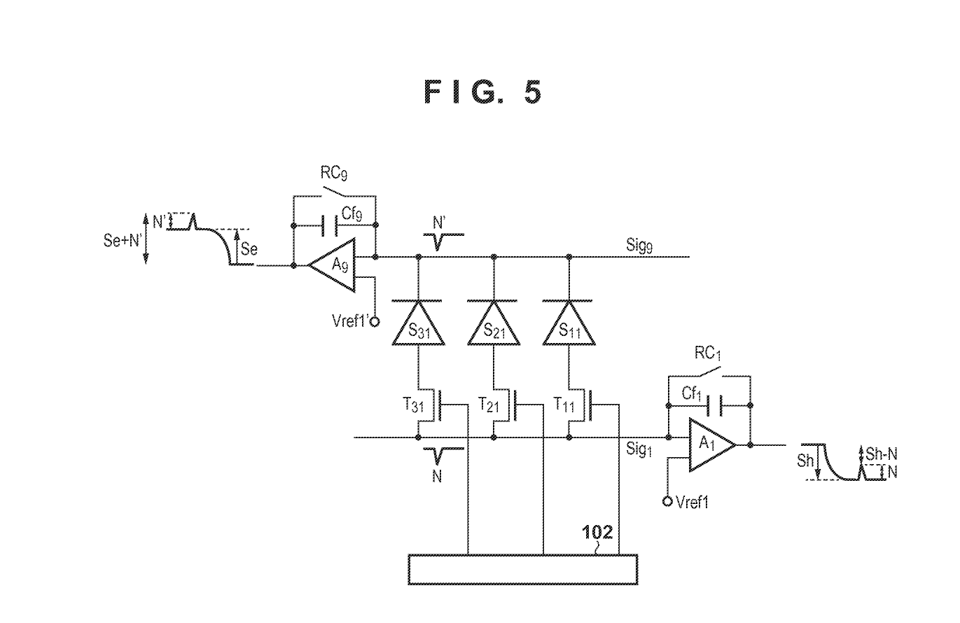

The respective sampling switches SHON₁ to SHON₉, SHON₉ to SHON₁₆, SHOS₁ to SHOS₉, SHOS₉ to SHOS₁₆, SHEN₁ to SHEN₈, SHEN₉ to SHEN₁₆, SHES₁ to SHES₈, and SHES₉ to SHES₁₆ of the sample and hold circuits 203 and 203′ can be driven at the same time. This can remove external noise which influences the detection unit 101. FIG. 5 is a circuit diagram for explaining the influence on the imaging apparatus 100₁ when external noise is mixed. FIG. 5 shows a portion including part of the detection unit 101, part of the processing unit 103, and part of the processing unit 103′. For example, signal lines Sig₁ and Sig₉ are arranged to correspond to the pixels P on the first column, and can be arranged in parallel to each other and spaced apart from each other at a distance of about several ten μm. If external noise is mixed, external noise N is mixed in the signal line Sig₁ and external noise N′ is mixed in the signal line Sig₉. Since, however, the impedances of the signal lines Sig₁ and Sig₉ are almost equal to each other, the external noises N and N′ can be in phase and their amounts can be equal. However, the output of the operational amplifier A₁ contains a negative signal component Sh and the output of the operational amplifier A₉ contains a positive signal Se, resulting in Sh−N in the operational amplifier A₁ and Se+N′ in the operational amplifier A₉ due to the external noises. Therefore, even if the output components change due to the external noises, it is possible to obtain (Sh−N)+(Se+N′)=Se+Sh by adding the first signal and second signal, and cancel the external noises by simultaneously driving the respective sampling switches. Consequently, the imaging apparatus 100₁ can reduce the influence of external noise.

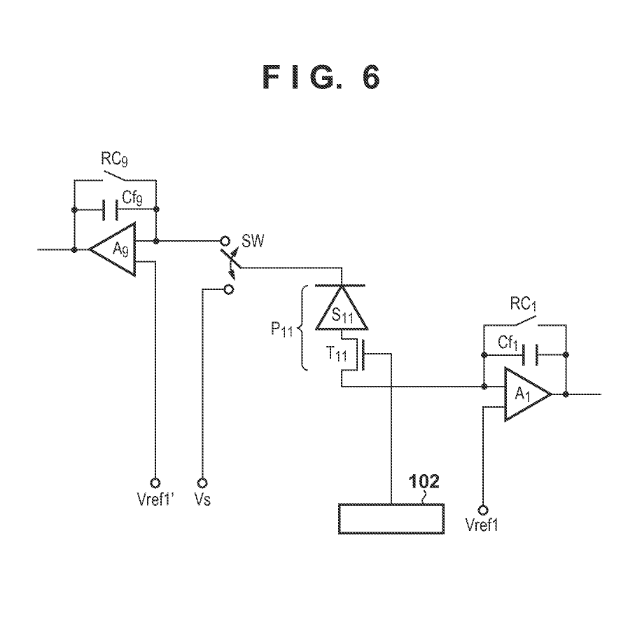

The imaging apparatus 100₁ need not always use both the first signal and the second signal, and may determine which of the first signal and second signal is used to generate image data, in accordance with an application purpose. When one of the first signal and second signal is used, it is possible to set one of the readout units 106 and 106′ (or at least some of the internal units thereof), which corresponds to the other of the first signal and second signal, in an idle mode. FIG. 6 shows another example of the arrangement of the imaging apparatus 100₁ according to this embodiment, and shows a portion including part of the detection unit 101, part of the processing unit 103, and part of the processing unit 103′. For example, a switch SW is arranged between the sensor S₁₁ and the operational amplifier A₉. The switch SW switches the connection destination of the sensor S₁₁ to the input terminal of the operational amplifier A₉ in a readout mode and to a bias line Vs in an idle mode. For example, the imaging apparatus 100₁ can have a plurality of operation modes such as a moving image shooting mode and a still image shooting mode, or a high-image quality mode in which a high S/N ratio is required and a low-power consumption mode in which a decrease in power consumption is prioritized. It is, therefore, possible to switch, in accordance with an application purpose, the switch SW to set the connection destination of the sensor S₁₁ to the bias line Vs, thereby setting the processing unit 103′ in an idle state. This can be done by a determination unit (not shown) which determines based on the operation mode which of the first signal and second signal is used to generate image data. Note that a predetermined reference voltage need only be set for the bias line Vs so that the processing unit 103 can read out the first signal while setting the processing unit 103′ in an idle state.

As described above, according to this embodiment, a first signal corresponding to the amount of one of the electron and hole of each of electron-hole pairs generated in each sensor S and a second signal corresponding to the amount of the other of the electron and hole of each of the electron-hole pairs are read out, and at least one of the first signal and second signal is used to generate image data in accordance with an application purpose. According to this embodiment, therefore, the present invention is advantageous in improving the performance of the imaging apparatus. Especially, it is possible to improve the S/N ratio by adding the first signal and the second signal. Furthermore, it is possible to suppress power consumption by setting, in an idle state, one of the processing unit 103 for reading out the first signal and the processing unit 103′ for reading out the second signal in accordance with the operation mode.

### Second Embodiment

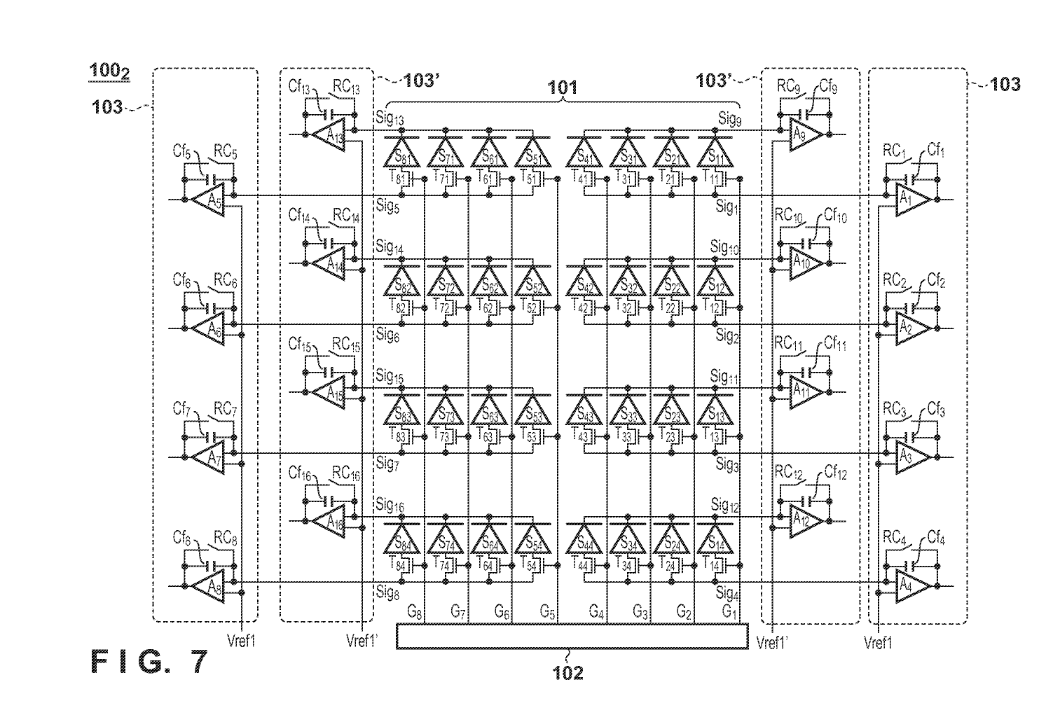

An imaging apparatus 100₂ according to the second embodiment will be described with reference to FIG. 7. FIG. 7 shows a portion of the imaging apparatus 100₂, which includes a detection unit 101, a driving unit 102, part of a processing unit 103, and part of a processing unit 103′. This embodiment is different from the first embodiment in that signal lines Sig₁ to Sig₈ and signal lines Sig₉ to Sig₁₆ are separated at the center of the detection unit 101. According to this embodiment, it is possible to simultaneously drive every two signal lines G (for example, signal lines G₁ and G₈, G₂ and G₇, G₃ and G₆, and G₄ and G₅). According to this embodiment, therefore, it is possible to read out a signal from each sensor S within about half the time, as compared with the first embodiment.

In this embodiment, it is possible to obtain the same effects as those in the first embodiment, and to shorten the time taken to read out pixel signals. Note that if the processing units 103 and 103′ are mounted in the detection unit 101 by TAB or COF, the processing units 103 and 103′ may be shifted by the pitch of pixels P, and mounted to overlap the detection unit 101.

### Third Embodiment

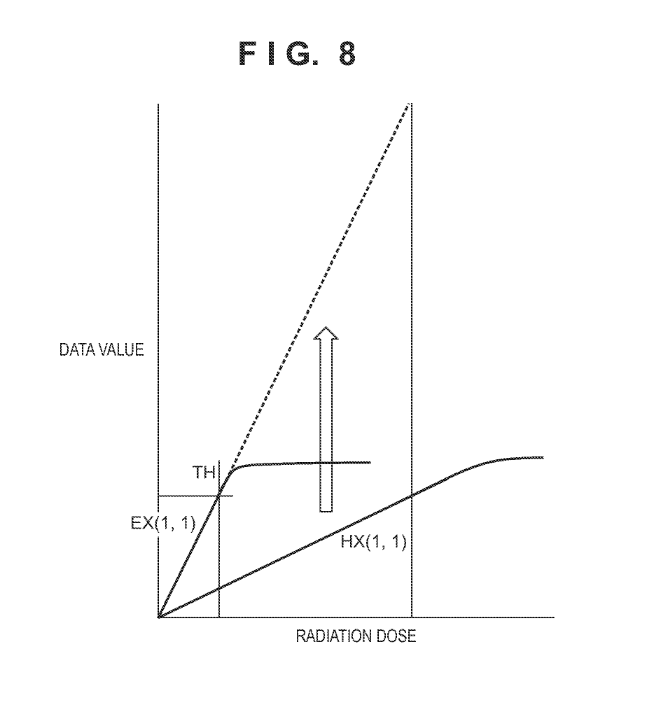

An imaging apparatus 100₃ according to the third embodiment will be described with reference to FIG. 8. In, for example, X-ray moving image shooting, an X-ray tube and an imaging apparatus can shoot a moving image while moving around a subject to be examined, thereby generating 3D image data. The imaging apparatus is required to have a wide dynamic range. The dynamic range can be represented by the ratio between a noise level and a saturation level in shooting.

In this embodiment, the gains (amplification factors) of processing units 103 and 103′ are changed by setting different capacitance values for integral capacitors Cf in amplification circuits 202 described above (different capacitance values for integral capacitors Cf₁ to Cf₈ and integral capacitors Cf₉ to Cf₁₆). It is possible to increase the S/N ratio by increasing the gain, but the saturation level of the signal decreases. On the other hand, the S/N ratio is decreased by decreasing the gain but the saturation level of the signal increases. By arranging the processing units 103 and 103′ having different gains, it is possible to obtain first and second signals having different signal levels.

FIG. 8 exemplarily shows the input/output characteristics of digital data HX(1, 1) according to a first signal and digital data EX(1, 1) according to a second signal, the first and second signals being read out from a sensor S₁₁. In FIG. 8, the abscissa represents a radiation dose, and the ordinate represents the value of data. If the gain of the processing unit 103′ is set to be, for example, four times the gain of the processing unit 103, the value of EX(1, 1) becomes four times the value of HX(1, 1). On the other hand, EX(1, 1) has a radiation dose for reaching the saturation level, which is ¼ the radiation dose of HX(1, 1), and has a narrow dynamic range.

The imaging apparatus 100₃ can include, for example, a determination unit (not shown). The determination unit may determine (or select) based on the irradiation dose of radiation which of the first signal and second signal is used to generate image data, and generate image data based on the determination result. Note that the determination processing need only be performed based on the result of comparing the irradiation dose of radiation with a predetermined threshold.

For example, EX(1, 1) can be selected when the radiation dose is smaller than a threshold TH, and HX(1, 1) can be selected when the radiation dose is larger than the threshold TH. The ratio of the gains of the processing units 103 and 103′ may be set to a different value for each pixel P or each column. Alternatively, EX(1, 1) may be selected when EX(1, 1) is smaller than a predetermined threshold, and HX(1, 1) may be selected when EX(1, 1) is larger than the predetermined threshold.

As described above, according to this embodiment, it is possible to obtain the same effects as those in the first embodiment. Especially, it is possible to increase the S/N ratio when the radiation dose is small, and to widen the dynamic range when the radiation dose is large, and thus the present invention is advantageous in improving the performance.

### Fourth Embodiment

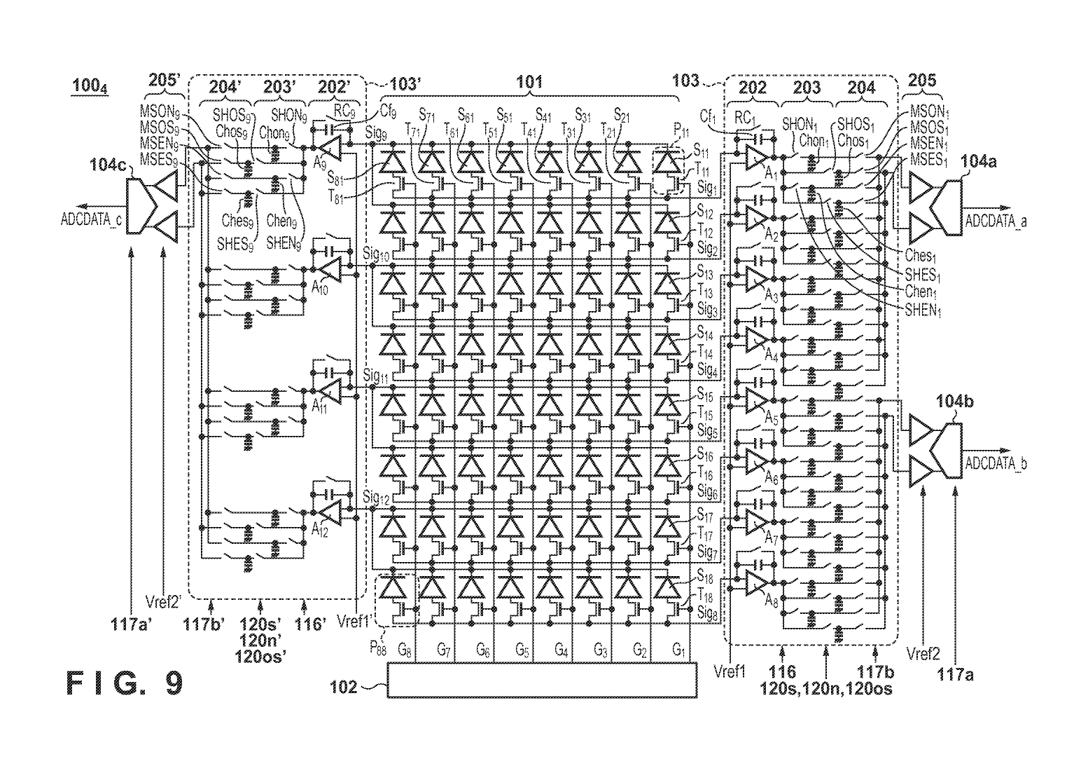

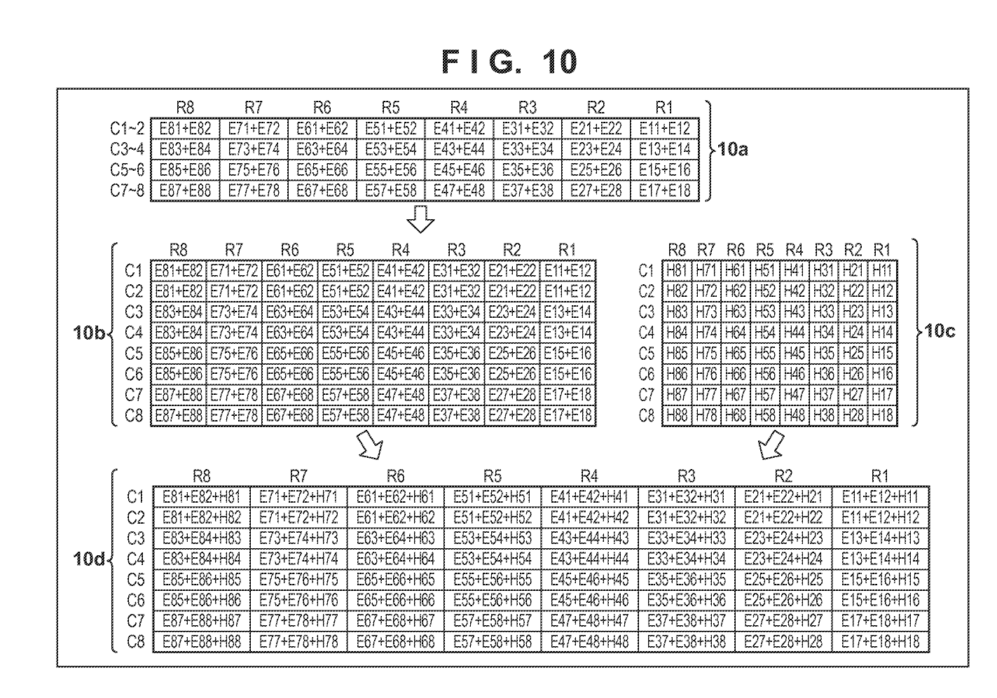

An imaging apparatus 100₄ according to the fourth embodiment will be described with reference to FIGS. 9 and 10. FIG. 9 shows an example of the arrangement of the imaging apparatus 100₄, similarly to the first embodiment (FIG. 2). This embodiment is different from the first embodiment in that respective units (an amplification circuit 202′, a sample and hold circuit 203′, and a multiplexer 204′) of a processing unit 103′ are arranged for every two columns. In this arrangement, it is possible to decrease the circuit scale of the processing unit 103′.

FIG. 10 is a view for explaining an image data processing method in the imaging apparatus 100₄. In FIG. 10, a table 10a shows data values obtained from the processing unit 103′ in correspondence with the columns and rows. Since the above-described respective units are arranged for every two columns, for example, the data value on the first row and the first and second columns is obtained based on second signals from sensors S₁₁ and S₁₂, and represented by E11+E12. In FIG. 10, a table 10b shows each data value shown in the table 10a for each row and each column. For example, the data value on the first row and the first column is E11+E12, and the data value on the first row and the second column is also E11+E12.

On the other hand, a table 10c of FIG. 10 shows data values obtained from the processing unit 103 in accordance with the columns and rows. For example, the data value on the first row and the first column is obtained based on a first signal from the sensor S₁₁, and represented by H11.

In FIG. 10, a table 10d shows the data values of image data obtained by adding the data values (that is, the table 10b) obtained from the processing unit 103′ and the data values (that is, the table 10c) obtained from the processing unit 103, respectively. For example, the data value on the first row and the first column is E11+E12+H11, and the data value on the first row and the second column is E11+E12+H12. That is, in this arrangement, part of data of an adjacent pixel is included to smooth a change in signal in image data.

According to this embodiment, it is possible to obtain the same effects as those in the first embodiment, and to decrease the circuit scale of the processing unit 103′. It is also possible to smooth a change in signal in image data.

Furthermore, according to this embodiment, the present invention is advantageous in an arrangement wherein which of the first signal and second signal is used to generate image data is determined based on the operation mode, and one of readout units 106 and 106′ may be set in an idle state in accordance with the operation mode. For example, if a high resolution is required, the imaging apparatus 100₄ can operate in a high-resolution mode in which first signals read out for each column are used. If no high resolution is required, the imaging apparatus 100₄ can operate in a low-resolution mode (for example, a low-power consumption mode or high-speed mode) in which second signals read out for every two columns are used. Furthermore, signals may be read out from the respective sensors S for each row or every two rows in accordance with the operation mode. As described above, in this arrangement, it is also possible to appropriately set the resolution, power consumption, and readout speed in accordance with the operation mode. Note that the present invention is not limited to the above-described operation modes, and it is possible to set one of the processing units 103 and 103′ in an idle state in accordance with whether the radiation dose is larger or smaller than a predetermined threshold.

### Fifth Embodiment

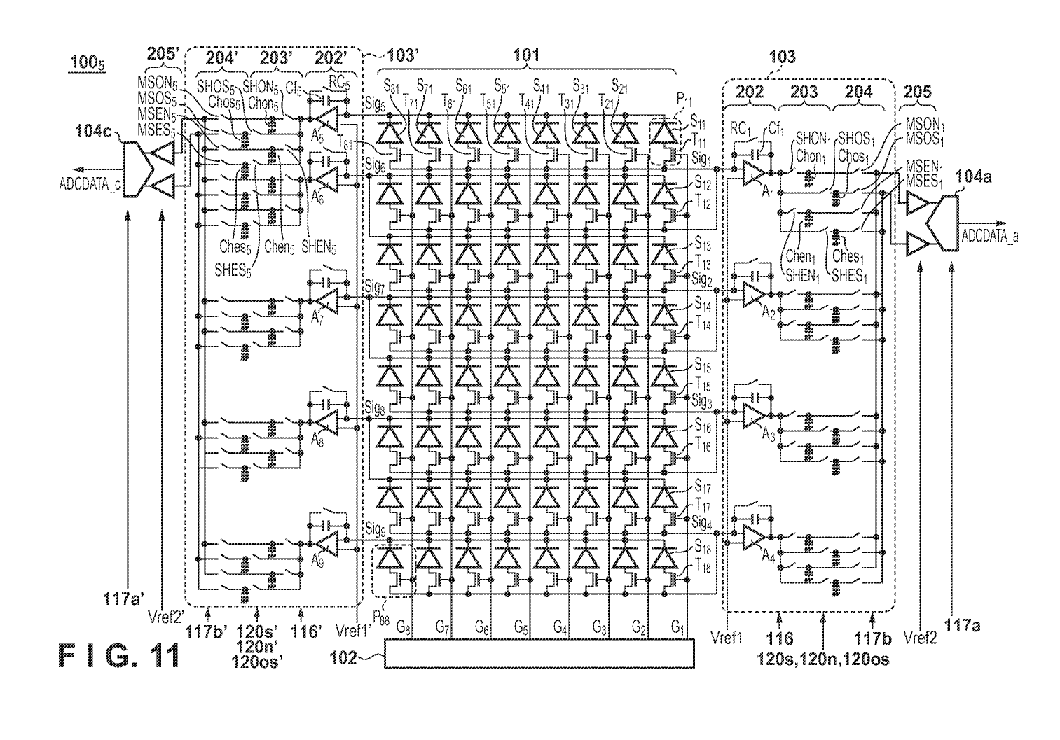

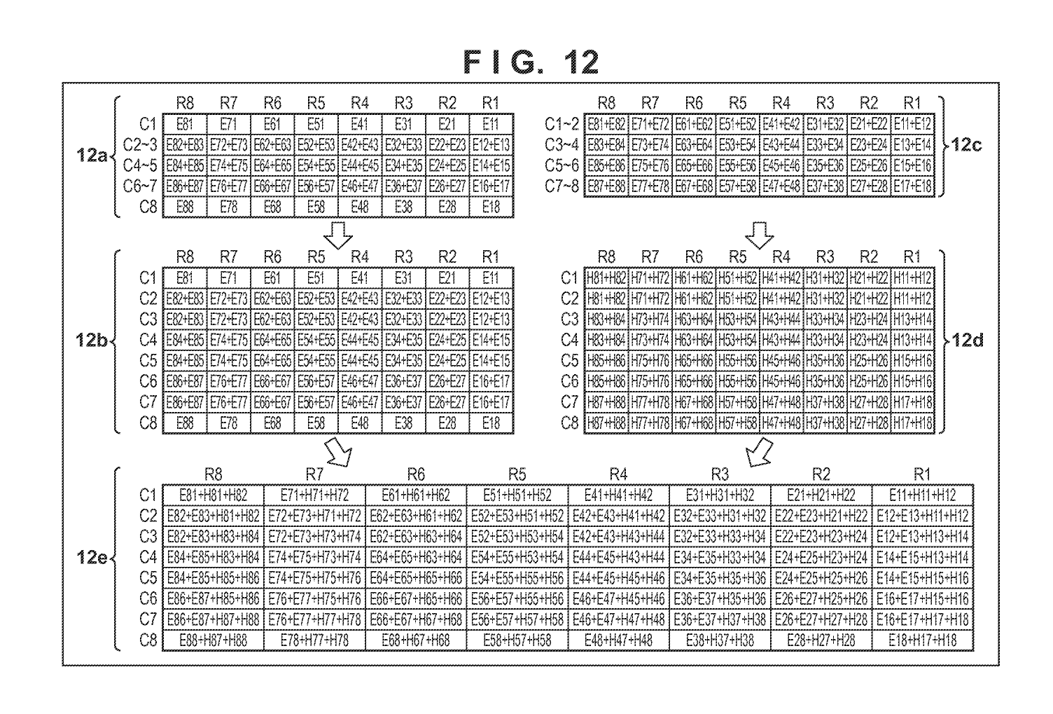

An imaging apparatus 100₅ according to the fifth embodiment will be described with reference to FIGS. 11 and 12. FIG. 11 shows an example of the arrangement of the imaging apparatus 100₅, similarly to the fourth embodiment (FIG. 9). This embodiment is different from the fourth embodiment in that respective units (an amplification circuit 202, a sample and hold circuit 203, a multiplexer 204) of a processing unit 103 are also arranged for every two columns. In this embodiment, a corresponding column of each set of units (an amplification circuit 202′, a sample and hold circuit 203′, and a multiplexer 204′) of a processing unit 103′ is different from that in the fourth embodiment with respect to the relationship with a detection unit 101. That is, five sets of units are respectively arranged to correspond to the first column, the second and third columns, the fourth and fifth columns, the sixth and seventh column, and the eighth column.

FIG. 12 is a view for explaining an image data processing method in the imaging apparatus 100₅, similarly to FIG. 10 (the fourth embodiment). In FIG. 12, a table 12a shows data values obtained from the processing unit 103′ in correspondence with the columns and rows. For example, the data value on the first row and the first column is obtained based on a second signal from a sensor S₁₁, and represented by E11. The data value on the first row and the second and third columns is obtained based on second signals from sensors S₁₁ and S₁₃, and represented by E12+E13. In FIG. 12, a table 12b shows each data value shown in the table 12a for each row and each column. For example, the data value on the first row and the first column is E11. The data value on the first row and the second column is E12+E13, and the data value on the first row and the third column is also E12+E13. Similarly, a table 12c of FIG. 12 shows data values obtained from the processing unit 103 in correspondence with the columns and rows. In FIG. 12, a table 12d shows each data value shown in the table 12c for each row and each column.

In FIG. 12, a table 12e shows the data values of image data obtained by adding the data values (that is, the table 12b) obtained from the processing unit 103′ and the data values (that is, the table 12d) obtained from the processing unit 103, respectively. For example, the data value on the first row and the first column is E11+E12+H11, and the data value on the first row and the second column is E11+E12+H12.

In the fourth embodiment, for example, the data value on the first row and the fourth column is E13+E14+H14, and contains the signals on the first row and the third column. On the other hand, in this embodiment, the data value on the first row and the fourth column is E14+E15+H13+H14, and contains the signals on the first row and the third column and the signals on the first row and the fifth column. According to this embodiment, therefore, it is possible to smooth a change in signal in image data, as compared with the fourth embodiment.

According to this embodiment, it is possible to obtain the same effects as those in the fourth embodiment, and decrease the circuit scale of the processing unit 103. It is also possible to smooth a change in signal in image data.

### Sixth Embodiment

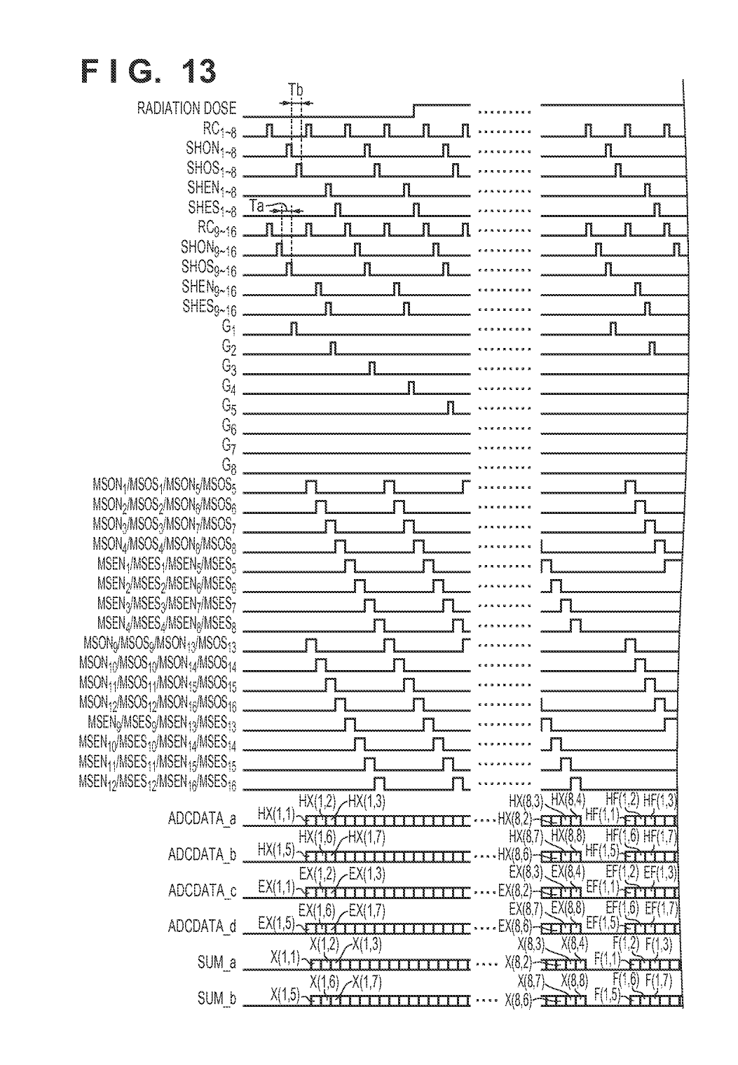

An imaging apparatus 100₆ according to the sixth embodiment will be described with reference to FIG. 13. For example, in shooting a moving image, pixel signals can be sequentially read out from respective sensors S while the imaging apparatus 100₆ is irradiated with radiation. By continuously reading out signals from the respective sensors S, it is possible to determine based on the readout signals that radiation irradiation has been performed, in an arrangement in which a radiation source and the imaging apparatus are not directly, electrically connected to each other.

If shooting is performed while the imaging apparatus 100₆ is irradiated with radiation, a noise current flows through a signal line due to a leakage current from a switch element T or capacitance coupling between the switch element T and the signal line, resulting in deterioration in image quality of image data such as unevenness. In this embodiment, a processing unit 103′ is used to read out noise components due to the noise current, and a processing unit 103 is used to read out signal components due to radiation irradiation.

FIG. 13 is a timing chart showing an example of the operation of the imaging apparatus 100₆, similarly to FIG. 3 (the first embodiment). After the imaging apparatus 100₆ is set in a standby state, reset switches RC₁ to RC₈ and RC₉ to RC₁₆ are sequentially set in a conductive state, thereby resetting integral capacitors Cf₁ to Cf₈ and Cf₉ to Cf₁₆ of the processing units 103 and 103′.

Next, sampling switches SHON₉ to SHON₁₆ of the processing unit 103′ are set in a conductive state for a predetermined period, and noise components are held by sampling capacitors Chon₉ to Chon₁₆, and sampled. After that, sampling switches SHOS₉ to SHOS₁₆ of the processing unit 103′ are set in a conductive state for a predetermined period, and signal components are held by sampling capacitors Chos₉ to Chos₁₆, and sampled. Simultaneously with sampling, sampling switches SHON₁ to SHON_{E} of the processing unit 103 are set in a conductive state for a predetermined period, and noise components are held by sampling capacitors Chon₁ to Chon₈, and sampled.

Next, the signal of a signal line G₁ is activated to set respective switch elements T₁₁ to T₁₈ in a conductive state. The first signals of respective sensors S₁₁ to S₁₈ are input to the processing unit 103 via signal lines Sig₁ to Sig₈, respectively. The second signals of the respective sensors S₁₁ to S₁₈ are input to the processing unit 103′ via signal lines Sig₉ to Sig₁₆, respectively. After that, sampling switches SHOS₁ to SHOS₈ of the processing unit 103 are set in a conductive state for a predetermined period, and signal components are held by sampling capacitors Chos₁ to Chos₈, and sampled. The above-described operation is sequentially performed for the remaining rows (rows corresponding to signal lines G₂ to G₈).

That is, the processing unit 103′ performs sampling twice before setting the switch elements T₁₁ to T₁₈ in a conductive state. First sampling is performed by the sampling switches SHON₉ to SHON₁₆ and the sampling capacitors Chong to Chon₁₆. Second sampling is performed by the sampling switches SHOS₉ to SHOS₁₆ and the sampling capacitors Chos₉ to Chos₁₆. In this example, since an A/D converter 104′ A/D-converts the difference between the result of the first sampling and that of the second sampling, if radiation irradiation starts during this period, noise components due to a noise current generated by the radiation irradiation are A/D converted.

On the other hand, the processing unit 103 performs first sampling before setting the switch elements T₁₁ to T₁₈ in a conductive state, and performs second sampling after setting them in a conductive state, that is, performs sampling twice in total. The first sampling is performed by the sampling switches SHON₁ to SHON₈ and the sampling capacitors Chon₁ to Chon₈. The second sampling is performed by the sampling switches SHOS₁ to SHOS₈ and the sampling capacitors Chos₁ to Chos₈. Signal components to be acquired can be read out from the difference between the result of the first sampling and that of the second sampling.

According to this embodiment, it is possible to reduce noise components due to shooting while the imaging apparatus is irradiated with radiation, thereby improving the S/N ratio. It is also possible to detect the start of radiation irradiation based on the result of A/D conversion of noise components read out by the processing unit 103′. According to this embodiment, therefore, the present invention is advantageous in improving the performance of the imaging apparatus.

As exemplified in FIG. 13, sampling is preferably performed so that the durations of periods Ta and Tb become equal. The period Ta indicates a period from when the sampling switches SHON₉ to SHON₁₆ are set in a conductive state until the sampling switches SHOS₉ to SHOS₁₆ are set in a conductive state. The period Tb indicates a period from when the sampling switches SHON₁ to SHON₈ are set in a conductive state until the sampling switches SHOS₁ to SHOS₈ are set in a conductive state. This can equalize the integral periods of respective operational amplifiers A, and cancel noise components with high accuracy.

As the radiation dose can change with time, it is possible to cancel noise components with high accuracy by performing sampling so that a period from sampling during the period Ta to sampling during the period Tb becomes short. For example, as exemplified in FIG. 13, sampling may be performed so that the sampling switches SHON₁ to SHON₈ and the sampling switches SHOS₉ to SHOS₁₆ are set in a conductive state during the same period.

Although the six embodiments have been described above, the present invention is not limited to them, and can be changed, as needed, in accordance with the objects, states, applications, functions, and other specifications. Other embodiments can also practice the present invention.

An imaging system to which a radiation imaging apparatus is applied is not limited to the arrangement of the radiation inspection apparatus RIA exemplified in FIG. 1, and the radiation imaging apparatus is applicable to another arrangement. The imaging system can include, for example, a radiation imaging apparatus, an arithmetic processing unit including an image processor, a display unit including a display, and a radiation source for generating radiation. Radiation (X-rays as a representative example) generated by the radiation source is transmitted through a subject to be examined, and the radiation imaging apparatus detects the radiation containing information about the inside of the body of the subject to be examined. The radiation imaging apparatus generates a radiation image based on the detected radiation information and, for example, information processing unit performs predetermined information processing, thereby generating image data. The generated image data is displayed on the display unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-091785, filed Apr. 24, 2013, which is hereby incorporated by reference herein in its entirety.

What is claimed is:

1. An imaging apparatus comprising:
a sensor array in which a plurality of sensors are arrayed;
a first readout unit configured to read out, from each of the plurality of sensors, a first signal corresponding to an amount of one of an electron and a hole of each of electron-hole pairs generated in the sensor array in response to irradiation with radiation or light; and
a second readout unit configured to read out, from each of the plurality of sensors, a second signal corresponding to an amount of the other of the electron and the hole of the electron-hole pairs.

2. The apparatus according to claim 1, further comprising
an image data generation unit configured to generate image data using at least one of the first signal read out by the first readout unit and the second signal read out by the second readout unit.

3. The apparatus according to claim 2, wherein
the image data generation unit generates image data using the first signal and the second signal.

4. The apparatus according to claim 2, further comprising
a determination unit configured to determine based on an irradiation dose of radiation or light amount which of the first signal and the second signal is used to generate the image data.

5. The apparatus according to claim 2, further comprising
a determination unit configured to determine based on an operation mode of the imaging apparatus which of the first signal and the second signal is used to generate the image data.

6. The apparatus according to claim 1, wherein
the first readout unit and the second readout unit include amplification units having different amplification factors, respectively.

7. The apparatus according to claim 3, wherein
the image data generation unit has an operation mode in which the image data is generated by adding the first signal and the second signal.

8. The apparatus according to claim 1, wherein
the first readout unit and the second readout unit include sample and hold circuits, respectively, and
a timing when the sample and hold circuit of the first readout unit samples the first signal is the same as that when the sample and hold circuit of the second readout unit samples the second signal.

9. The apparatus according to claim 1, further comprising
an output range extension unit configured to extend output ranges of the first readout unit and the second readout unit.

10. The apparatus according to claim 1, wherein
at least one of the first readout unit and the second readout unit has a readout mode and an idle mode and, in the idle mode, fixes, at a reference voltage, a signal line for reading out a signal from each of the plurality of sensors.

11. The apparatus according to claim 1, wherein
the sensor array further includes a plurality of switch elements which are arrayed in a one-to-one correspondence with the sensors, and
the first readout unit is electrically connected to the plurality of switch elements, and the second readout unit is electrically connected to the plurality of sensors.

12. An imaging system comprising
an imaging apparatus according to claim 1; and
an image processor configured to perform image processing for information from the imaging apparatus.
